(19) United States
(12) Patent Application Publication
(10) Pub. No.: US 2003/0139937 A1
(43) Pub. Date: Jul. 24, 2003

(54) Remote la carte system and a method

(76) Inventor: Joon Suk Lee, Fairfax, VA (US)

Correspondence Address: David Tichane, Registered Patent Attorney, 979 Pinto Palm Terrace, #24, Sunnyvale, CA, 94087, US

(21) Appl. No.: 10/056,723

(22) Filed: Jan. 22, 2002

(51) Int. Cl. G06F 17/60

(52) U.S. Cl. 705/1

(57) ABSTRACT

Disclosed is a remote la carte system and method. The remote la carte system comprises a display part for displaying menu and/or game screen; a data input part for selecting and inputting food; a controller for reading food menu data stored in a memory part and displaying in the display part, scanning the data inputted in said data input part, and outputting a food order data and a scent emission control data; a send/receive part for sending food order data to a main control office, receiving an answer signal outputted from the main control office, and sending the answer signal to said controller; a heat generation control part for driving heat generation plate in which condensed scent related to the food in the menu is placed; and a scent selection control part for diffusing scent emitted by the heat generation plate opening scent bag depending upon the scent diffusion control data outputted in said controller.

### TECHNICAL FIELD

The present invention relates to a remote la carte system and method, and more particularity to a remote la carte system and method thereof which displays dishes or food available to order. When a customer chooses specific dishes it diffuses scents of the ordered food. At the same time, information concerning the ordered dish is transmitted to the central control office (kitchen) where the dish is prepared. Feedback, including the time to prepare the food, is displayed to the customer.

### BACKGROUND ARTS

A plurality of tables is spread to accommodate customers in casual or specialized restaurants. Each of tables is attached or assigned table numbers to deliver ordered dishes correctly.

However, restaurants incur much expense because of the need to hire servers to write orders and table numbers onto a order sheet. Also, it can be troublesome for the customer to call the server to order the dish while sitting at the table.

### DISCLOSURE OF THE INVENTION

Therefore, the object of the present invention is to provide a remote la carte system and a method. The system employs a motion detector to sense when the customer sits at the table. Then food or dishes available to order are displayed on a screen for the customer. The specific scent corresponding to the selected food is presented to the customer. Simultaneously the order is transmitted to the central control office (kitchen). While waiting for the order to be prepared, the customer may play a game on the screen.

To achieve the above objects, according to one aspect of the present invention, there is provided a remote la carte system comprising: a display part for displaying menu so that a customer can order food or dishes and simultaneously displaying game screen; a data input part for selecting and inputting food from menu displayed in the display part; a controller for reading food menu data stored in a memory part and displaying in the display part, scanning the data inputted in the data input part, and outputting a food order data and a scent emission control data; a send/receive part for sending food order data outputted in the controller to a main control office(kitchen), receiving an answer signal outputted from the main control office, and sending the answer signal to said controller; a heat generation control part, depending upon heat generation control data outputted from the controller, for driving heat generation plate in which a condensed scent related to the food in the menu is placed; and a scent selection control part for diffusing scent emitted by the heat generation plate opening scent bag depending upon the scent diffusion control data outputted in said controller.

According to another aspect of the present invention, there is provided a remote la carte method comprising: displaying food menu and guiding food order automatically when a customer is sensed; deciding whether a customer chooses the food among displayed menu in the displaying step; displaying material and content of selected food in the food selection deciding step; regulating material and content of the food displayed in the food material and content displaying step; deciding whether the food in which material and content are regulated is ordered in the food material regulation step; and displaying cooking hour and simultaneously displaying food order when a food is ordered in the food order deciding step and displaying time for cooking the ordered food.

### BRIEF DESCRIPTION OF THE DRAWINGS

The above objects, and other features and advantages of the present invention will become more apparent by describing embodiments thereof with reference to the attached drawings in which:

FIG. 1 is a block diagram showing the remote la carte system according to the present invention;

FIG. 2 is a flowchart showing operating process of the remote la carte system and method according to the present invention.

### BEST MODE FOR CARRYING OUT THE INVENTION

Hereinafter, a preferred embodiment of the present invention will be described with reference to the accompanying drawings.

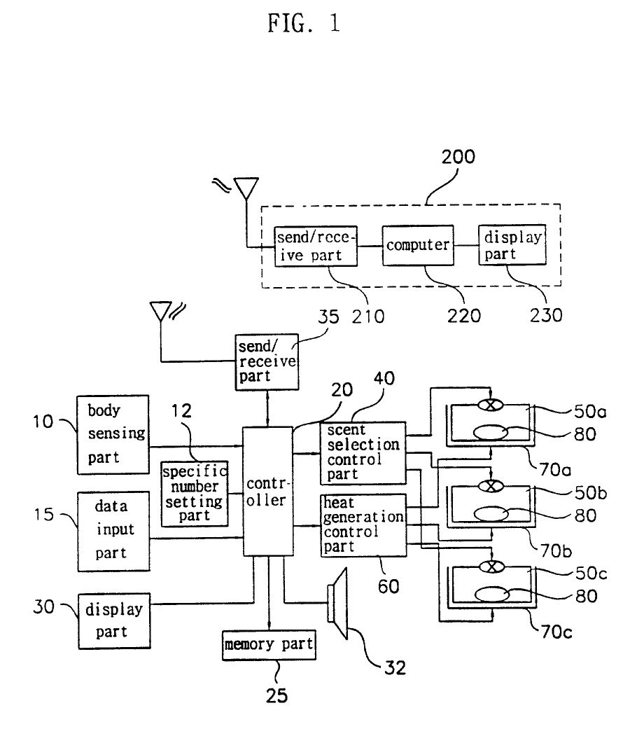

FIG. 1 shows a block diagram of the remote la carte according to the present invention. Human body sensing part 10 is comprised to send the sensed data to a controller 20 when it sense a customer getting near to the table or taking a seat by the sensor affixed in the table or the chair, and said controller 20 is comprised to read the food menu data stored in a memory part 25 and to send to a display part 30, and is comprised to scan the data inputted in a data input part 15 and to output the food order data and the scent diffusion control data.

In addition, a send/receive part 35 is comprised to send the food order data and number of a specific table number set up in the specific number set part 12 to a central control office 200 placed in a kitchen and is comprised to receive a respond signal outputted from the central control office 200 and to send the respond signal to the controller 20, wherein the display part 30 is comprised display menu so that a customer can order food or dishes, and alternatively is comprised to display a game screen.

A heat generation control part 60 is comprised to drive the heat generation plates 70a, 70b, and 70c wherein each of plates 70a, 70b, and 70c comprise a condensed scent 80 which is selected depending upon the heat generation control data outputted from the controller 20, and a scent selection control part 40 is comprised to be run depending upon the scent diffusion control data outputted from the controller 20 and to open the scent bag 50a, 50b, or 50c and then to discharge scent emitted by heat generation plate 70a, 70b, or 70c.

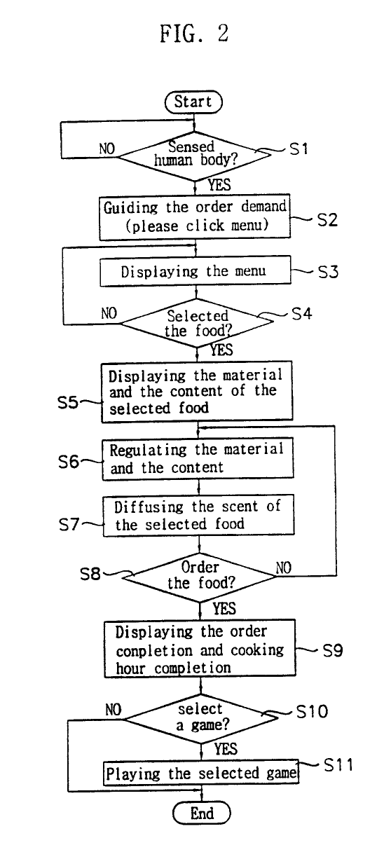

Operation of the remote la carte system that is comprised as above will be described as following with reference to the flowchart illustrated in FIG. 2.

When a customer approaches the table or is seated in the chair where the system according to the present invention is established, the human body sensing part 10 senses the human body in step S1 of FIG. 2 and send the sensed data to the controller 20. Then the controller 20 does order guidance broadcasting using speaker or display an order demand data in the display part 30 in step S2.

When the order guidance broadcasting is completed as above, the controller 20 reads the food menu data stored in the memory part 25 and displays it in the display part 30 in step S3 and then the controller 20 decides whether the food is selected in step S4, for instance when the food is selected, in order for the customer to control the material and a content of the food, the material and the content of the food which is selected are displayed in the display part 30 in step S5.

When, in step S6, the customer controls the material and the content of the food displayed in the step S5, a prescribed control signal supplied in the scent selection control part 40 and the heat generation control part 60 and then one of the heat generation plates 70a, 70b, and 70c is driven so that the condensed scent 80 is put in order to diffuse the scent which represent the food with automatic movement in step S7 and simultaneously one selected of scent bags 50a, 50b, and 50c is opened, and it is to decide whether the food is ordered in step S8, for example, when the food is ordered, the selected food and number thereof and the specific number of the table is sent through the send/receive part 35 to the central control office 200.

When the send/receive part 210 in the central control office 200 receives the data outputted from the remote la carte system, the central control office 200 send the data to a computer 220, display the table number and the material and a content of selected food in the display part 230, and send the answer signal replied to the data to the send/receive part 35 in the remote la carte system.

When the la carte system receives the answer signal outputted from the central control office 200, the food order completion and cooking hour are displayed automatically to the display part 30 in step S9, it is to decide whether the customer selects a game during cooking hour in step S10, and when he selects a game, the game is displayed in the display part 30 in step S11.

### INDUSTRIAL APPLICABILITY

As mentioned above, according to the present invention, the remote la carte system and method permits the customer to select and order food, observe the material and content of the food before ordering, enjoy the scent of the ordered food, and play a game during the cooking hour.

1. A remote la carte system comprising:
a display part for displaying menu so that a customer can order food or dishes and simultaneously displaying game screen;
a data input part for selecting and inputting food from menu displayed in said display part;
a controller for reading food menu data stored in a memory part and displaying in the display part, scanning the data inputted in said data input part, and outputting a food order data and a scent emission control data;
a send/receive part for sending food order data outputted in said controller to a main control office (kitchen), receiving an answer signal outputted from the main control office, and sending the answer signal to said controller;
a heat generation control part, depending upon heat generation control data outputted from said controller, for driving heat generation plate in which condensed scent related to the food in the menu is placed; and
a scent selection control part for diffusing scent emitted by the heat generation plate opening scent bag depending upon the scent diffusion control data outputted in said controller.

2. A remote la carte method comprising:
displaying food menu and guiding food order automatically when a customer is sensed;
deciding whether a customer chooses the food among displayed menu in said displaying step;
displaying material and content of selected food in said food selection deciding step;
regulating material and content of the food displayed in said food material and content displaying step;
deciding whether the food in which material and content are regulated is ordered in said food material regulation step; and
displaying cooking hour and simultaneously displaying food order when a food is ordered in said food order deciding step and displaying time for cooking the ordered food.

3. The remote la carte method as claimed in claim 2, further comprising diffusing scent related to the food regulated in said food material regulating step.

4. The remote la carte method as claimed in claim 2, further comprising displaying a game screen as a customer wishes during cooking time displayed in said cooking time displaying step.
